(19) United States
(12) Patent Application Publication
(10) Pub. No.: US 2024/0321083 A1
(43) Pub. Date: Sep. 26, 2024

(54) MONITORING SYSTEM FOR PORTABLE ARTICLES

(71) Applicant: SE-KURE CONTROLS, INC., Franklin Park, IL (US)

(72) Inventor: David M. Adams, Stone Park, IL (US)

(21) Appl. No.: 18/678,475

(22) Filed: May 30, 2024

Related U.S. Application Data
(63) Continuation of application No. 16/864,482, filed on May 1, 2020, now abandoned.
(60) Provisional application No. 62/848,660, filed on May 16, 2019.

(51) Int. Cl. G08B 25/00; G06V 40/13; G08B 13/14

(52) U.S. Cl. CPC G08B 25/008; G08B 13/14; G06V 40/13

(57) ABSTRACT

A system disclosed herein comprises a monitoring system for monitoring system breaches and having an armed state and an unarmed state. The monitoring system is operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article. A signal generator is operatively connected to the monitoring system to generate a detectable signal as an incident of a system breach. A programmable actuator system is operatively connected to the monitoring system and is operable to enable reprogramming of the system and to change the monitoring system between the armed state and the unarmed state, and comprises a fingerprint detector. In response to an input generated by an authorized fingerprint detected by the fingerprint detector the actuator system is enabled to selectively reprogram the system or to change the monitoring system from the armed state into the unarmed state or to change the monitoring system from the unarmed state into the armed state.

### CROSS-REFERENCE TO RELATED APPLICATIONS

This application is a continuation of U.S. patent application Ser. No. 16/864,482, filed May 1, 2020, which claims priority to U.S. Provisional Application No. 62/848,660 filed May 16, 2019.

### BACKGROUND OF THE INVENTION

### Field of the Invention

This invention relates to portable consumer articles and, more particularly, to a monitoring system for the articles that generates a signal as an incident of a system breach.

### Background Art

A multitude of monitoring/security systems have been devised to limit unauthorized handling and theft of portable articles. The theft problem is particularly prevalent in consumer electronics stores where expensive consumer articles such as cell phones, and the like, are displayed in large numbers and handled by many shoppers contemplating purchase.

The monitoring systems that have been devised vary widely in terms of construction, how they operate, and the particular breaches that they are designed to detect.

Typically, regardless of the precise construction of the monitoring system, it is configured to have an armed state and an unarmed state. In the unarmed state, the system can be set up to monitor one or more articles, as at a particular display location. Once the desired articles have been integrated into the monitoring system, the system can be placed in the armed state, as a result of which the designed-for system breach will cause generation of a signal that is detectable by itself and/or sent to another device or location for processing. By disarming a system, previously monitored articles may be handled and moved about without restriction. A disarmed system might be changed by being connected to another article, reconfigured, reprogramed, etc.

Various actuators have been devised to facilitate the changing of the state of such systems by only authorized personnel. Currently, systems use keys, RFID, I-buttons, keypads, etc. Most of these systems require a user to carry or obtain a separate, commonly dedicated, device to be used when the system is armed and/or disarmed.

Keypads that are operable without an external device are prone to being compromised by creative thieves who may independently obtain access codes and/or observe the input thereof by an authorized person.

Given the number of such monitoring systems that may be present in a particular retail establishment, it is important for efficiency that authorized personnel be able to readily arm and disarm the systems as to permit articles to be moved between displays and allow reconfiguration of such systems, without compromising overall security.

One option is to have a number of different arming/disarming devices with each being operable with security systems associated with only one displayed device, or a limited number of displayed devices. In a large retail operation, this could require dozens of such arming/disarming devices to be kept on hand in a manner that their use can be coordinated with their related security systems. This may be highly inconvenient and may create situations where such devices are not readily available when needed.

Alternatively, a “master” device may be usable to operate large numbers, or all, of the monitoring systems in a display area. If the master device is controlled by an unauthorized person, the security of large numbers of devices may be compromised, thereby requiring re-keying, reprogramming, or other system modifications to safeguard the devices.

### SUMMARY OF THE INVENTION

In one form, the invention is directed to the combination of a portable article and a system for monitoring the portable article. The monitoring system has an armed state and an unarmed state. The monitoring system in the armed state is configured to generate a signal as an incident of a system breach. The monitoring system includes an actuator system that is operable to change the monitoring system between the armed state and the unarmed state. The monitoring system is changeable at least one of: a) from the armed state into the unarmed state; and b) from the unarmed state into the armed state in response to an input generated by a detected fingerprint.

In one aspect, the system comprises a monitoring system for monitoring system breaches and having an armed state and an unarmed state. The monitoring system is operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article. A signal generator is operatively connected to the monitoring system to generate a detectable signal as an incident of a system breach. A programmable actuator system is operatively connected to the monitoring system and is operable to enable reprogramming of the system and to change the monitoring system between the armed state and the unarmed state, and comprises a fingerprint detector. In response to an input generated by an authorized fingerprint detected by the fingerprint detector the actuator system is enabled to selectively reprogram the system or to change the monitoring system from the armed state into the unarmed state or to change the monitoring system from the unarmed state into the armed state.

In one form, the monitoring system is changed from one of the armed state and unarmed state into the other of the armed state and the unarmed state as an incident of the input being generated.

In one form, as an incident of the input being generated, the actuator system is operable to change the monitoring system from one of the armed and unarmed states into the other of the armed and unarmed states.

In one form, the actuator system includes a fingerprint detector that has at least one of: a) an optical; b) a capacitive; c) an ultrasound; and d) a thermal scanner.

In one form, the actuator system has a fingerprint detector that is configured to operate by pressing one or more fingers on a surface.

In one form, the actuator system has a fingerprint detector that is configured to operate by dragging the finger relative to a surface.

In one form, the system breach that causes the generation of the detectable signal is movement of the portable article in relationship to a support for the portable article.

In one form, the system breach that causes the generation of the detectable signal is a change in orientation of the portable article.

In one form, the system breach that causes the generation of the detectable signal is a movement of the portable article outside of a prescribed area.

In one form, the system breach that causes the generation of the detectable signal is a separation of a part of the monitoring system from the portable article.

In one form, the system breach that causes the generation of the detectable signal is a reconfiguration of a part of the monitoring system.

In one form, the monitoring system includes a signal generator on the portable article and a signal receiver. The system breach results from the signal generator and signal receiver either: a) establishing communication; or b) having a communication interrupted.

In one form, the monitoring system includes a signal receiver on the portable article and a signal generator. The signal breach results from the signal generator and signal receiver either: a) establishing communication; or b) having a communication interrupted.

In one form, the system breach that causes the generation of the detectable signal is movement of the portable article.

In one form, the generated signal is communicated to a receiver.

In one form, the receiver generates a separate signal that can be identified by a user.

In one form, the generated signal is an audible signal.

In one form, the generated signal is a visual signal.

In one form, the portable article is a portable electronic article.

In one form, the portable article is a portable smart device displayed on a stand with the monitoring system in the armed state.

### BRIEF DESCRIPTION OF THE DRAWINGS

FIG. 1 is a schematic representation of the combination of a portable article and a system for monitoring the portable article, according to the invention;

FIG. 2 is a schematic representation as in FIG. 1 and showing a modified form of monitoring system;

FIG. 3 is a schematic representation of a connection between the inventive monitoring system and a portable article;

FIG. 4 is a schematic representation showing one specific form of connection as shown generically in FIG. 3; and

FIG. 5 is a schematic representation showing another specific type of connection as shown generically in FIG. 3.

### DETAILED DESCRIPTION OF THE PREFERRED EMBODIMENT

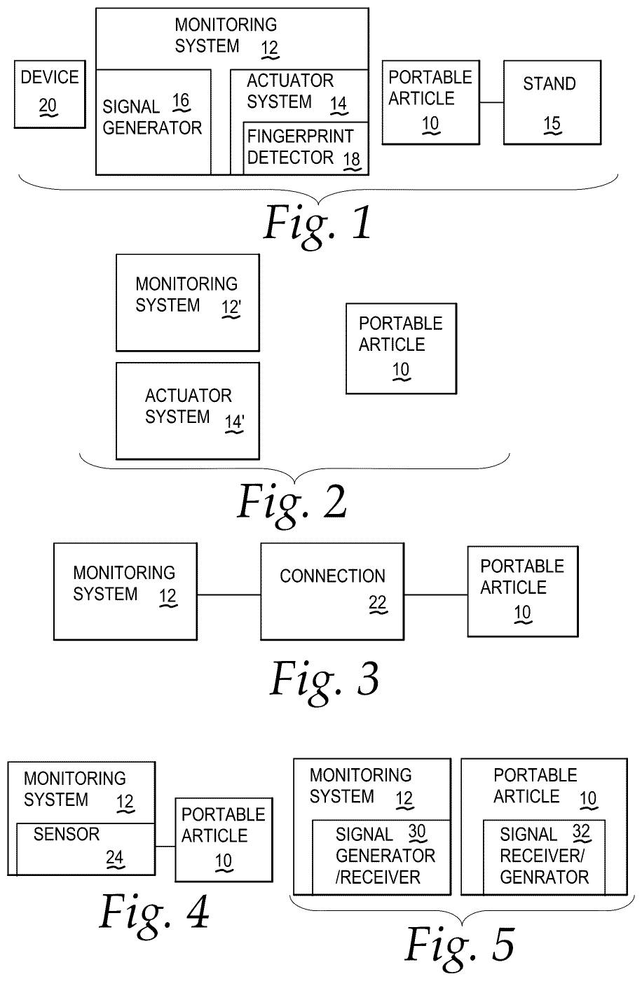

In FIG. 1, one form of the invention is depicted schematically, consisting of a portable article 10 and a monitoring system 12, with an actuator system 14, for the portable article 10.

The portable article 10 may be any type of article, typically of the type displayed in retail establishments for inspection or purchase on site. The article may range from an article of clothing to an expensive or complicated electronic article. As one example, the portable article 10 may be a mobile smart device, with a display having an input surface, that is mounted/displayed on a stand 15.

The monitoring system 12 has an armed state and an unarmed state. The monitoring system 12 has a signal generator 16. The monitoring system 12 is configured so that the signal generator 16 generates a signal as an incident of a system breach.

The actuator system 14 has a fingerprint detector 18. Upon detecting an authorized fingerprint, an input is generated whereupon the actuator system 14 is operable to change, or allow change of, at least one of: a) the monitoring system from the armed state into the unarmed state; and b) the monitoring system from the unarmed state into the armed state.

Upon detecting the authorized fingerprint, the actuator system 14 may automatically cause the monitoring system 12 to change from the armed/unarmed state into the unarmed/armed state.

Alternatively, upon detecting the authorized fingerprint, the actuator system 14 may be changed into a mode wherein it is capable of being operated, as by further inputs, to change the state of the monitoring system and/or to make other system changes.

In FIG. 2, a modified form of monitoring system is shown at 12′ wherein the actuator system 14′ is a separate subsystem. The systems 12′, 14′ otherwise function as the corresponding systems in FIG. 1 to monitor the portable article 10.

The signal generator 16 may itself be capable of producing a signal that is detectable, as by sight and/or sound. Alternatively, the signal generator may generate an input to a separate device 20, as at a remote location, where it can be viewed and/or otherwise processed. For example, the signal may be sent to a monitoring location, as to a computer or cell phone, from which information may be gathered and/or other action might be initiated. For example, details regarding the breach might be obtained, such as identification of an article and/or its location. Follow-up procedures might be initiated as to track the subject article, notify others of the breach, etc.

As shown in FIG. 3, there is some connection 22 between the monitoring system 12 and portable article 10. This generic showing is intended to encompass a connection that is part of the monitoring system 12 and/or portable article and/or partially or entirely independent thereof. For example, the connection 22 may be a mechanical connection such as a tether or an electrical connection that may be wired or wireless.

The connection may be between the monitoring system 12 and some part of the portable article 10 that already exists. Alternatively, as shown in FIG. 4, a sensor 24 on the monitoring system 12 might be integrated into, or attached to, the portable article 10. The sensor 24 might detect movement of the portable article 10 at or in relationship to a support therefor. The sensor 24 might detect an abrupt movement of the portable article 10. The sensor 24 might sense a change in orientation of the portable article 10. In any of these instances, the movement constitutes the system breach that causes the generation of the signal by the generator 16.

The system breach may result from movement of the portable article outside of a prescribed area which breaks or establishes a connection between the monitoring system 12 and the portable article 10 as to cause the signal generation.

For example, as shown in FIG. 5, the monitoring system 12 may have a signal generator/receiver 30 with the portable article having a cooperating signal receiver/generator 32. The system may be configured so that there is a communication of signals between the monitoring system 12 and portable article 10 that is interrupted when the system is breached. For example, the signal may be interrupted when the monitoring system 12 and portable article 10 are separated beyond a predetermined distance.

Alternatively, the interruption may occur by reason of a system reconfiguration. For example, the sensor 24 and the portable article 10 may be separated in an unauthorized fashion whereby the communication is interrupted. This may occur as the sensor 24 is removed from the portable article 10, if there is a severance of an electrical communication line between the monitoring system 12 and portable article 10, etc.

In an alternative design, a signal receiver/generator 30 at an exit location senses the presence of the signal receiver/generator 32 and causes a breach signal to be generated.

Essentially, the generic showing of components in FIGS. 1-5 is intended to encompass virtually every type of portable article monitoring system that exists, and that might be devised, and that has different states-armed and unarmed-between which the monitoring system 12 is changed in normal operation, as to facilitate setup and changing of monitoring configurations.

The fingerprint detector may be constructed utilizing well-known and developed fingerprint scanning/reading technology. Fingerprint reading technology usable, without limitation, is that in the optical, capacitive, ultrasound, and thermal categories. The fingerprint may be processed by pressing one or more fingers on a surface or by dragging the finger(s) relative to a surface.

The actuator system 14 might be programmed to recognize one or more fingerprints such that it might be inoperable by other than those persons authorized and whose prints are recognizable. The actuator system might be reprogrammable upon an authorized person inputting his/her print. Backup actuator devices could be implemented together with the print reading capability; however, as noted above, this may increase the likelihood of a system compromise.

The foregoing disclosure of specific embodiments is intended to be illustrative of the broad concepts comprehended by the invention.

1. A system comprising:
a monitoring system for monitoring system breaches and having an armed state and an unarmed state, the monitoring system being operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article;
a signal generator operatively connected to the monitoring system to generate a detectable signal as an incident of a system breach; and
a programmable actuator system operatively connected to the monitoring system and operable to enable reprogramming of the system and to change the monitoring system between the armed state and the unarmed state, and comprising a fingerprint detector, and in response to an input generated by an authorized fingerprint detected by the fingerprint detector the actuator system is enabled to selectively reprogram the system or to change the monitoring system from the armed state into the unarmed state or to change the monitoring system from the unarmed state into the armed state.

2. The system according to claim 1 wherein the monitoring system is changed from one of the armed state and unarmed state into the other of the armed state and the unarmed state as an incident of the input being generated.

3. The system according to claim 1 wherein as an incident of the input being generated, the actuator system is operable to change the monitoring system from one of the armed and unarmed states into the other of the armed and unarmed states.

4. The system according to claim 1 wherein the fingerprint detector comprises at least one of: a) an optical; b) a capacitive; c) an ultrasound; and d) a thermal scanner.

5. The system according to claim 1 wherein the fingerprint detector is configured to operate by pressing one or more fingers on a surface.

6. The system according to claim 1 wherein the fingerprint detector is configured to operate by dragging a finger relative to a surface.

7. The system according to claim 1 wherein the system breach that causes the generation of the detectable signal is movement of the portable article in relationship to a support for the portable article.

8. The system according to claim 1 wherein the system breach that causes the generation of the detectable signal is a change in orientation of the portable article.

9. The system according to claim 1 wherein the system breach that causes the generation of the detectable signal is a movement of the portable article outside of a prescribed area.

10. The system according to claim 1 wherein the system breach that causes the generation of the detectable signal is a separation of a part of the monitoring system from the portable article.

11. The system according to claim 1 wherein the system breach that causes the generation of the detectable signal further comprises a reconfiguration of a part of the monitoring system.

12. The system according to claim 1 wherein the monitoring system comprises a signal generator on the portable article and a signal receiver and a system breach results from the signal generator and signal receiver either: a) establishing communication; or b) having a communication interrupted.

13. The system according to claim 1 wherein the monitoring system comprises a signal receiver on the portable article and a signal generator, and a signal breach results from the signal generator and signal receiver either: a) establishing communication; or b) having a communication interrupted.

14. The system according to claim 1 wherein the generated signal is communicated to a receiver.

15. The system according to claim 14 wherein the receiver generates a separate signal that can be identified by a user.

16. The system according to claim 1 wherein the generated signal is an audible signal.

17. The system according to claim 1 wherein the generated signal is a visual signal.

18. The system according to claim 1 wherein the portable article is a portable electronic article.

19. The system according to claim 1 wherein the portable article is a portable smart device displayed on a stand with the monitoring system in the armed state.
